(19) United States
(12) Patent Application Publication
(10) Pub. No.: US 2012/0087063 A1
(43) Pub. Date: Apr. 12, 2012

(54) ELECTRODE STRUCTURE AND LITHIUM ION CAPACITOR WITH THE SAME

(75) Inventors: Ji Sung Cho, Gyeonggi-do (KR); Sang Kyun Lee, Gyeonggi-do (KR); Bae Kyun Kim, Gyeonggi-do (KR)

(73) Assignee: SAMSUNG ELECTRO-MECHANICS CO., LTD.

(21) Appl. No.: 13/019,507

(22) Filed: Feb. 2, 2011

(30) Foreign Application Priority Data
Oct. 8, 2010 (KR) 10-2010-0098271

(51) Int. Cl. H01G 9/032; H01B 5/00; H01G 9/15

(52) U.S. Cl. 361/525; 361/528; 174/126.1

(57) ABSTRACT

Provided is an anode structure of an energy storage device such as a lithium ion capacitor. The anode structure includes a current collector and an active material layer formed on the current collector, and the active material layer includes an active material, a conductive material for providing conductivity to the active material layer, and graphite surface-coated with amorphous carbon.

### CROSS-REFERENCE(S) TO RELATED APPLICATIONS

This application claims the benefit under 35 U.S.C. Section 119 of Korean Patent Application Ser. No. 10-2010-0098271, entitled “Electrode Structure And Lithium Ion Capacitor With The Same” filed on Oct. 8, 2010, which is hereby incorporated by reference in its entirety into this application.”

### BACKGROUND OF THE INVENTION

1. Field of the Invention

The present invention relates to an electrode structure and a lithium ion capacitor with the same, and more particularly, to an electrode structure and a lithium ion capacitor with the same that are capable of improving an output density, low temperature characteristics, and durability.

2. Description of the Related Art

Among next generation energy storage devices, a device referred to as an ultra capacitor or a supercapacitor is coming into the spotlight as a next generation energy storage device due to a high charge/discharge speed, high stability and environmentally friendly characteristics. A conventional supercapacitor includes an electrode structure, a separator, an electrolyte, and so on. The supercapacitor is driven by an electrochemical reaction mechanism in which an electric power is applied to the electrode structure to selectively adsorb carrier ions in the electrolyte to the electrode.

In recent times, a typical supercapacitor may be a lithium ion capacitor (LIC). In general, the lithium ion capacitor is a supercapacitor including a cathode formed of activated carbon and an anode formed of various kinds of graphite materials, in which lithium ions are used as carrier ions. Since the lithium ion capacitor has a relatively higher output density than a secondary battery, efforts for using the lithium ion capacitor as an auxiliary backup power supply of a transportation means such as a vehicle is being continued. However, in order to use the lithium ion capacitor as a backup power supply of the transportation means, higher output density than that of the current technology is needed. In addition, low temperature characteristics and durability of the lithium ion capacitor must be further improved.

### SUMMARY OF THE INVENTION

The present invention has been invented in order to overcome the above-described problems and it is, therefore, an object of the present invention to provide an electrode structure capable of improving output density of a lithium ion capacitor.

It is another object of the present invention to provide an electrode structure capable of improving low temperature characteristics and durability of a lithium ion capacitor.

It is still another object of the present invention to provide a lithium ion capacitor capable of output density.

It is yet another object of the present invention to provide a lithium ion capacitor capable of improving low temperature characteristics and durability.

In accordance with one aspect of the present invention to achieve the object, there is provided an electrode structure used in an energy storage device, including: a current collector; and an active material layer formed on the current collector, wherein the active material layer includes: an active material; a conductive material for providing conductivity to the active material layer; and graphite surface-coated with amorphous carbon.

According to an embodiment of the present invention, the surface of the active material may be coated with the amorphous carbon.

According to an embodiment of the present invention, the graphite may have a particle size smaller than that of the active material and larger than that of the conductive material.

According to an embodiment of the present invention, the graphite may have a sphere shape.

According to an embodiment of the present invention, the graphite may be used as an active material for adsorbing carrier ions of a charge/discharge reaction mechanism of an energy storage device and a conductive material for providing conductivity to the active material layer.

According to an embodiment of the present invention, the active material may include at least one of soft carbon, hard carbon, activated carbon, carbon aero gel, polyacrylonitrile (PAN), carbon nano fiber (CNF), activated carbon nano fiber (ACNF), and vapor grown carbon fiber (VGCF).

According to an embodiment of the present invention, the current collector may include a metal foil formed of at least one of copper, nickel, aluminum, and stainless steel.

In accordance with another aspect of the present invention to achieve the object, there is provided a lithium ion capacitor including: an electrolyte containing lithium ions; and a cathode structure and an anode structure disposed to oppose each other with a separator interposed therebetween in the electrolyte, wherein the anode structure includes: an anode current collector; and an anode active material layer formed on the anode current collector, and the anode active material layer includes: an anode active material; a conductive material for providing conductivity to the anode active material layer; and graphite surface-coated with amorphous carbon.

According to an embodiment of the present invention, the surface of the anode active material may be coated with the amorphous carbon.

According to an embodiment of the present invention, the graphite may have a particle size smaller than that of the active material and larger than that of the conductive material.

According to an embodiment of the present invention, the graphite may have a sphere shape.

According to an embodiment of the present invention, the graphite may be used as an active material for adsorbing carrier ions of a charge/discharge reaction mechanism of an energy storage device and a conductive material for providing conductivity to the active material layer.

According to an embodiment of the present invention, the active material may include at least one of soft carbon, hard carbon, activated carbon, carbon aero gel, polyacrylonitrile (PAN), carbon nano fiber (CNF), activated carbon nano fiber (ACNF), and vapor grown carbon fiber (VGCF).

According to an embodiment of the present invention, the current collector may include a metal foil formed of at least one of copper, nickel, aluminum, and stainless steel.

According to an embodiment of the present invention, the cathode structure may include a cathode current collector; and a cathode active material layer formed on the cathode current collector, wherein the cathode active material layer includes a cathode active material that reversibly dope anions coupled to the lithium ions.

According to an embodiment of the present invention, the electrolyte may include at least one of LiPF₆, LiBF₄, LiSbF₆, LiAsF₅, LiClO₄, LiN, CF₃SO₃, LiC, LiN(SO₂CF₃)₂, LiN(SO₂C₂F₅)₂, LiC(SO₂CF₃)₂, LiPF₄(CF₃)₂, LiPF₃(C₂F₅)₃, LiPF₃(CF₃)₃, LiPF₅(iso-C₃F₇)₃, LiPF₅(iso-C₃F₇), (CF₂)₂(SO₂)₂NLi, and (CF₂)₃(SO₂)₂NLi.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a view showing an anode structure in accordance with an exemplary embodiment of the present invention;

FIG. 2 is an enlarged view of a region A shown in FIG. 1; and

FIG. 3 is a view showing a lithium ion capacitor in accordance with an exemplary embodiment of the present invention.

### DETAILED DESCRIPTION OF THE PREFERABLE EMBODIMENTS

Hereinafter, exemplary embodiments of the present invention will be described in detail. However, the present invention is not limited to the embodiments disclosed below but can be implemented in various forms. The following embodiments are described in order to enable those of ordinary skill in the art to embody and practice the present invention. To clearly describe the present invention, parts not relating to the description are omitted from the drawings. Like numerals refer to like elements throughout the description of the drawings.

The terms used throughout this specification are provided to describe embodiments but not intended to limit the present invention. In this specification, a singular form includes a plural form unless the context specifically mentions. When an element is referred to as “comprises” and/or “comprising”, it does not preclude another component, step, operation and/or device, but may further include the other component, step, operation and/or device unless the context clearly indicates otherwise.

Hereinafter, an anode structure and a lithium ion capacitor with the same in accordance with an exemplary embodiment of the present invention will be described with reference to the accompanying drawings.

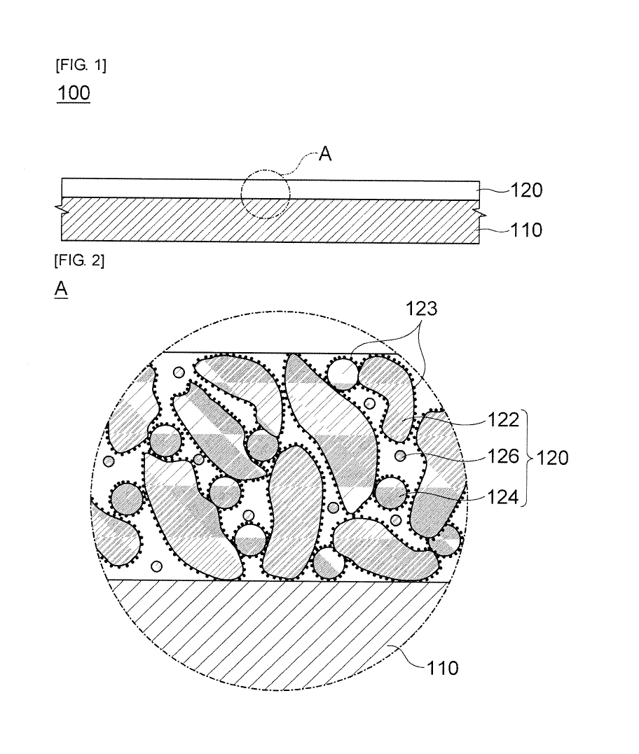

FIG. 1 is a view showing an anode structure in accordance with an exemplary embodiment of the present invention, and FIG. 2 is an enlarged view of a region A shown in FIG. 1.

Referring to FIGS. 1 and 2, an electrode structure 100 in accordance with an exemplary embodiment of the present invention may be an electrode for a predetermined energy storage device. For example, the electrode structure 100 may be used as an anode (negative electrode) of a lithium ion capacitor (LIC) among energy storage devices, which are referred to as an ultra capacitor or a supercapacitor.

The electrode structure 100 may include a current collector 110 and an active material layer 120.

The current collector 110 may be formed of various kinds of metal materials. For example, the current collector 110 may be a metal foil including at least one of copper, nickel, aluminum, and stainless steel.

The active material layer 120 may be a film coated on a surface of the current collector 110. The active material layer 120 may be a film formed by manufacturing a predetermined active material composition and coating a surface of the metal foil with the active material composition. The active material layer 120 may include an active material 122, graphite 124, and a conductive material 126.

The active material 122 may be a material for adsorbing lithium ions (LI⁺) as carrier ions for charging/discharging the lithium ion capacitor. The active material 122 may be selected from various kinds of carbon materials. For example, the carbon material may include at least one of soft carbon, hard carbon, activated carbon, carbon aero gel, polyacrylonitrile (PAN), carbon nano fiber (CNF), activated carbon nano fiber (ACNF), and vapor grown carbon fiber (VGCF).

Meanwhile, the surface of the active material 122 may be coated with amorphous carbon 123. The amorphous carbon 123 may have a crystalline structure in which carbon atoms and ions are irregularly arranged to form non-uniform crystalline structure. Accordingly, since the active material 122 has a structure that reaction with the lithium ions (Li⁺) is increased, when the electrode structure 100 is used as an anode of the energy storage device, output density of the energy storage device can be increased.

The graphite 124 may be a material for adsorbing the lithium ions (Li⁺). In addition, the graphite 124 may be a material for providing conductivity to the active material layer 120. Accordingly, the graphite 124 may function as a conductive material, in addition to use as an active material in the active material layer. In order to increase utilization of the graphite 124 as the active material, the surface of the graphite 124 may also be coated with the amorphous carbon 123.

Here, the graphite 124 may have a smaller size than that of the active material 122. The graphite 124 may be adjusted to have a generally sphere shape. Accordingly, the graphite 124 may be filled into a space between the active materials 122. For example, the graphite 124 may be adjusted such that an average grid surface gap d002 is about 0.330 nm to 0.340 nm. In addition, the graphite 124 may be adjusted such that a volume reference D50 is about 0 μm to 50 μm.

The conductive material 126 may be a material for providing conductivity to the anode active material layer 120. The conductive material 126 may be a conductive material having a smaller particle size than that of the active material 122. More preferably, the conductive material may be conductive particles having a smaller size of sphere shape than that of the graphite 124. For this, the conductive material 126 may be provided as a powder shape, and may be provided to fill a space between the active material 122 and the graphite 124.

The conductive material 126 may use various kinds of conductive materials. For example, the conductive material 126 may use at least one of carbon black, ketjen black, carbon nano tube, graphene, and acetylene black. Here, in consideration of use purpose and characteristics of the conductive material 126, the conductive material 126 may have substantially a sphere shape. For example, it may be advantageous that the conductive material 126 is provided as a smaller size than that of the active material 122 and the graphite 124 to be easily filled into a space between the active material 122 and the graphite 124, improving energy density of the active material. In consideration of this, the conductive material 126 may use carbon black having a smaller size of sphere shape than that of the active material 122 and the graphite 124. For another example, the conductive material 126 may use various kinds of metal powders. For still another example, the conductive material 126 may use acetylene black.

In addition, the active material layer 120 may further include a binder (not shown). The binder may be additives for improving application and adhesion efficiency of the active material layer 120. For example, the binder may use various kinds of resins.

As described above, the electrode structure 100 in accordance with an exemplary embodiment of the present invention may include the current collector 110 and the active material layer 120 coated on the current collector 110, and the active material layer 120 may include the active material 122 coated with the amorphous carbon 123. Accordingly, since the electrode structure in accordance with the present invention has a structure in which the active material 122 increases a reaction area with the electrolyte, when the electrode structure 100 is used as an anode of the lithium ion capacitor, the reaction efficiency between the active material 122 and the lithium ions (Li⁺) may be increased to increase charge density of the lithium ion capacitor.

The electrode structure 100 in accordance with an exemplary embodiment of the present invention includes the active material layer 120 coated on the current collector 110, and the active material layer 120 may further include a graphite 124 surface-coated with amorphous carbon 123. The graphite 124 may be used as a conductive material for applying conductivity to the active material layer 120, as well as used as an active material of adsorbing carrier ions for charge/discharge reaction of the energy storage device. Accordingly, since the electrode structure in accordance with the present invention includes the active material layer capable of improving reaction with carrier ions and decreasing an equivalent series resistance (ESR), output density of the energy storage device can be improved.

In addition, the electrode structure 100 in accordance with an exemplary embodiment of the present invention includes the current collector 110 and the active material layer 120 coated on the current collector 110, and the active material layer 120 may include an active material 122, a graphite 124 having a smaller size than that of the active material 122, and the conductive material 126 having a smaller size than that of the graphite 124. The graphite 124 and the conductive material 126 may be used as a conductive material of applying conductivity to the anode active material layer 120. Accordingly, since the anode structure in accordance with the present invention has the anode active material layer 120 having a structure in which different conductive materials are filled, when the anode structure is used as an anode of the lithium ion capacitor, charge density of the lithium ion capacitor can be increased.

Continuously, a lithium ion capacitor in accordance with an exemplary embodiment of the present invention will be described. Here, description overlapping that of the electrode structure 100 described with reference to FIGS. 1 and 2 will be omitted or simplified.

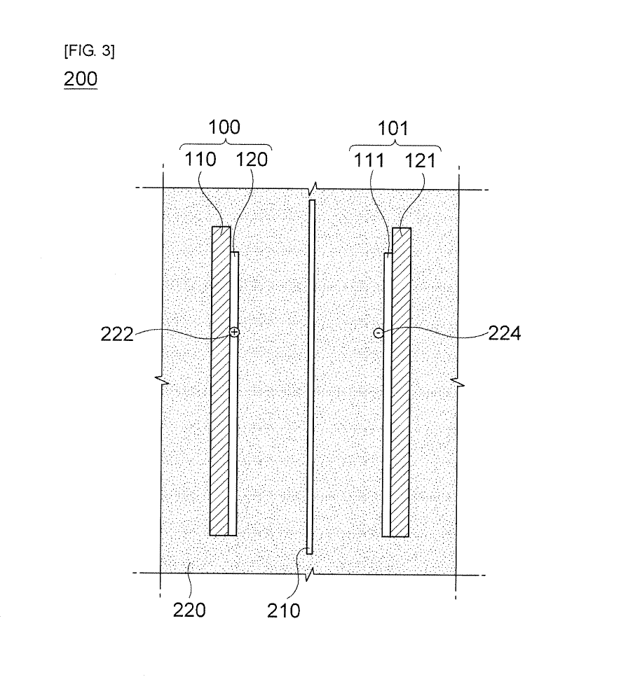

FIG. 3 is a view showing a lithium ion capacitor in accordance with an exemplary embodiment of the present invention. Referring to FIGS. 1 to 3, an energy storage device 200 in accordance with an exemplary embodiment of the present invention may include an anode structure 100, a cathode structure 101, a separator 210, and an electrolyte 220.

The anode structure 100 may be disposed to oppose the cathode structure 101 with the interposition of the separator 210. The anode structure 100 may include an anode current collector 110 and an anode active material layer 120 coated on the anode current collector 110. The anode structure 100 may have the same configuration as the electrode structure 100 described with reference to FIGS. 1 and 2. For example, the anode current collector 110 and the anode active material layer 120 of the anode structure 100 may have the same configuration as the current collector 110 and the active material layer 120 described with reference to FIGS. 1 and 2. Accordingly, detailed description of the anode current collector 110 and the anode active material layer 120 will be omitted.

The cathode structure 101 may include a cathode current collector 111 and a cathode active material layer 121. The cathode current collector 111 may be formed of aluminum foil. The cathode active material of the cathode active material layer 121 may include various kinds of carbon materials. The cathode active material may use a material capable of reversibly doping negative ions 224 such as hexafluorephosphate (PF6⁻) coupled to lithium ions. For example, the cathode active material may use activated carbon.

The separator 210 may be disposed between the anode and cathode structures 100 and 101. The separator 210 may be formed of at least one of non-woven fabric, poly tetra fluoroethlyene (PTFE), porous film, craft paper, cellulose-based electrolytic paper, rayon fiber, and other various kinds of sheets.

The electrolyte 220 may be a composition manufactured by melting a predetermined electrolytic salt into solvent. The electrolytic salt may include cations 222 having a charge reaction mechanism occluded into the anode active material layer 120. In addition, the cations 222 may be operated to have the charge reaction mechanism adsorbed to a surface of the cathode active material layer 121 of the cathode structure 101. The electrolytic salt may use lithium-based electrolytic salt. The lithium-based electrolytic salt may be a salt including lithium ions (Li⁺) as carrier ions between the anode structure 100 and the cathode structure 101 during charge/discharge operation of the lithium ion capacitor 200. For example, the lithium-based electrolytic salt may include at least one of LiPF₆, LiBF₄, LiSbF₆, LiAsF₅, LiClO₄, LiN, CF₃SO₃, and LiC. The lithium-based electrolytic salt may include at least one of LiN(SO₂CF₃)₂, LiN(SO₂C₂F₅)₂, LiC(SO₂CF₃)₂, LiPF₄(CF₃)₂, LiPF₃(C₂F₅)₃, LiPF₃(CF₃)₃, LiPF₅(iso-C₃F₇)₃, LiPF₅(iso-C₃F₇), (CF₂)₂(SO₂)₂NLi, and (CF₂)₃(SO₂)₂NLi.

In addition, the solvent may include at least one of annular carbonate and linear carbonate. For example, the annular carbonate may use at least one of ethylene carbonate (EC), propylene carbonate (PC), butylenes carbonate (BC), and vinylethlyene carbonate (VEC). The linear carbonate may use at least one of dimethyl carbonate (DMC), methyl ethyl carbonate (MEC), diethyl carbonate (DEC), methlypropyl carbonate (MPC), dipropyl carbonate (DPC), methylbutyl carbonate (MBC), and dibutyl carbonate (DBC). Otherwise, various kinds of ether, ester and amide-based solvent may be used.

Hereinafter, a method of manufacturing a lithium ion capacitor will be described in detail. Here, description overlapping that of the anode structure 100 and the lithium ion capacitor 200 including the same will be omitted or simplified.

<Example of Manufacture of Anode Structure>

An anode active material, acetylene black, and polyethylene fluoride vinylidene were mixed at a weight ratio of 80:10:10 to manufacture a mixture and the mixture was added to a solvent such as normal-methylpyrolidone to manufacture slurry. The slurry was applied onto an aluminum foil as a current collector. The aluminum foil was formed of a thin plate having a thickness of about 20 μm. At this time, a method of applying the slurry was formed by a doctor blade method. In addition, after drying the slurry, the aluminum foil was cut to manufacture an anode. The thickness of the manufactured anode is adjusted to about 30 μm.

A lithium metal foil adhered to the anode via a separator was set to a predetermined vessel so that lithium ions of the lithium metal foil is doped to the anode. At this time, a doting rate of the lithium ions was adjusted to about 85% of the anode capacity. Through the above processes, the anode structure to which lithium ions are pre-doped was manufactured.

<Example of Manufacture of Cathode Structure>

An activated material that can be obtained by an alkali incubation method having a relative surface area of about 2200 m²/g was used as a positive electrode active material. Activated carbon powder, acetylene black and polyethylene fluoride vinylidene were mixed at a weight ratio of 80:10:10 to manufacture a mixture and the mixture was added to a solvent such as normal-methylpyrolidone to manufacture slurry. The slurry was applied onto an aluminum foil as a current collector. The aluminum foil was formed of a thin plate having a thickness of about 20 μm, and a method of applying the slurry was formed by a doctor blade method. In addition, after drying the slurry, the aluminum foil was cut to manufacture an anode. The thickness of the manufactured anode is adjusted to about 50 μm.

<Example of Manufacture of Electrolyte>

A mixture in which Ethylene carbonate (EC):propylene carbonate (PC):diethyl carbonate (DEC) were mixed at a weight ratio of 3:1:2 was prepared, and then, lithium hexafluorephosphate (LiPF₆) is solved in the mixture to concentration of 1.2 mol/L, manufacturing electrolyte.

<Example of Manufacture of Lithium Ion Capacitor Cell>

A separator was disposed between the anode structure and the cathode structure manufactured as above, and the resultant matter was submerged in the electrolyte and inserted into a case formed of a laminate film and sealed therein. Accordingly, a lithium ion capacitor cell was manufactured.

<Test for Lithium Ion Capacitor Cell>

An electrochemical test of the lithium ion capacitor manufactured as above was performed as follows. At this time, a lithium ion capacitor cell used as a comparative example does not use a graphite and amorphous carbon coating technique, and may include an anode structure on which an anode active material is formed. Other components (for example, electrolyte, a separator, a cathode structure, and so on) of the cell used as the comparative example may be the same as the lithium ion capacitor cell in accordance with the present invention.

A discharge capacity was used as a reference when a cycle in which a predetermined static current is charged to 4.0V and discharged to 2.0V equal to the current on charge is repeated five times. Makoto discharge current uses a lithium capacitor cell capacitor as a reference in which current can be discharged for one hour, which is referred to as 1C. The following table 2 uses a discharge capacity as a reference discharge capacity when five cycles are measured as Makoto discharge current. A discharge capacity maintaining rate when 100C is performed with respect to 1C was calculated as the following formula, and its values are represented as the following tables.

TABLE 1
Estimation of Discharge Characteristics

| | Capacity | Capacity | Capacity | ESR |
|---|---|---|---|---|
| | (10cycle) | (100cycle) | (200cycle) | (1 kHz) |
| Invention | 1120 F. | 986 F. | 851 F. | 1.3 mΩ |
| Comparative | 1080 F. | 886 F. | 778 F. | 1.6 mΩ |
| Example | | | | |

TABLE 2
Estimation of Low Temperature Characteristics

| | F.(25□) | F.(−20□) | F.(−30□) | F.(−40□) |
|---|---|---|---|---|
| Invention | 1120 | 840 | 672 | 448 |
| Comparative | 1080 | 767 | 605 | 367 |
| Example | | | | |

TABLE 3
Estimation of High Temperature Cycle Durability at 60□

| | Capacity Maintaining | Resistance Increased |
|---|---|---|
| | (after 10000 cycles) | (after 1000 cycles) |
| Invention | 96.30% | 112% |
| Comparative Example | 95.80% | 115% |

Reviewing the above test results, the lithium ion capacitor in accordance with an exemplary embodiment of the present invention represents higher capacity maintaining rate and lower equivalent series resistance according to charge/discharge cycle repetition even at a low temperature, in comparison with a comparative example in which hard carbon is used as an anode active material. Accordingly, it will be appreciated that the lithium ion capacitor in accordance with the present invention can improve discharge characteristics, resistance characteristics, and low temperature characteristics.

As can be seen from the foregoing, an electrode structure in accordance with the present invention includes an active material layer formed on a current collector, and the active material layer may include an active material surface-coated with amorphous carbon. Accordingly, since the electrode structure in accordance with the present invention includes an active material layer of improving reaction with carrier ions of a charge/discharge reaction mechanism, output density of an energy storage device can be improved.

The electrode structure of the present invention includes an active material layer formed on a current collector, and the active material layer may further include graphite surface-coated with amorphous carbon. The graphite may be used as a conductive material for providing conductivity to the active material layer, as well as an active material of adsorbing carrier ions for charge/discharge reaction of an energy storage device. Accordingly, since the electrode structure in accordance with the present invention includes the active material layer capable of improving reaction with carrier ions and reducing an equivalent series resistance (ESR), energy density of the energy storage device can be improved.

The lithium ion capacitor in accordance with the present invention includes an anode structure and a cathode structure opposite to each other with a separator interposed therebetween in electrolyte, and the anode structure may have a structure in which a surface of an active material layer formed on a current collector is coated with amorphous carbon. Accordingly, since the lithium ion capacitor in accordance with the present invention increases reaction between the active material layer of the anode structure and lithium ions of a charge/discharge reaction mechanism, output density can be improved.

The lithium ion capacitor in accordance with the present invention includes an anode structure and a cathode structure opposite to each other with a separator interposed therebetween in electrolyte, and the anode structure may include an active material layer including graphite surface-coated with amorphous carbon. The graphite may be used as a conductive layer for increasing conductivity of the active material layer, as well as an active material for adsorbing lithium ions of the electrolyte. Accordingly, since the lithium ion capacitor in accordance with the present invention includes the active material layer capable of improving reaction with lithium ions and decreasing an equivalent series resistance, output density can be improved.

This invention may be embodied in different forms and should not be construed as limited to the embodiments set forth herein. Rather, these embodiments are provided so that this disclosure will be thorough and complete, and will fully convey the scope of the invention to those skilled in the art. As described above, although the preferable embodiments of the present invention have been shown and described, it will be appreciated by those skilled in the art that substitutions, modifications and variations may be made in these embodiments without departing from the principles and spirit of the general inventive concept, the scope of which is defined in the appended claims and their equivalents.

What is claimed is:

1. An electrode structure used in an energy storage device, comprising:
a current collector; and
an active material layer formed on the current collector,
wherein the active material layer comprises:
an active material;
a conductive material for providing conductivity to the active material layer; and
graphite surface-coated with amorphous carbon.

2. The electrode structure according to claim 1, wherein the surface of the active material is coated with the amorphous carbon.

3. The electrode structure according to claim 1, wherein the graphite has a particle size smaller than that of the active material and larger than that of the conductive material.

4. The electrode structure according to claim 1, wherein the graphite has a sphere shape.

5. The electrode structure according to claim 1, wherein the graphite is used as an active material for adsorbing carrier ions of a charge/discharge reaction mechanism of an energy storage device and a conductive material for providing conductivity to the active material layer.

6. The electrode structure according to claim 1, wherein the active material comprises at least one of soft carbon, hard carbon, activated carbon, carbon aero gel, polyacrylonitrile (PAN), carbon nano fiber (CNF), activated carbon nano fiber (ACNE), and vapor grown carbon fiber (VGCF).

7. The electrode structure according to claim 1, wherein the current collector comprises a metal foil formed of at least one of copper, nickel, aluminum, and stainless steel.

8. A lithium ion capacitor comprising:
an electrolyte containing lithium ions; and
a cathode structure and an anode structure disposed to oppose each other with a separator interposed therebetween in the electrolyte,
wherein the anode structure includes:
an anode current collector; and
an anode active material layer formed on the anode current collector, and
the anode active material layer includes:
an anode active material;
a conductive material for providing conductivity to the anode active material layer; and
graphite surface-coated with amorphous carbon.

9. The lithium ion capacitor according to claim 8, wherein the surface of the anode active material is coated with the amorphous carbon.

10. The lithium ion capacitor according to claim 8, wherein the graphite has a particle size smaller than that of the active material and larger than that of the conductive material.

11. The lithium ion capacitor according to claim 8, wherein the graphite has a sphere shape.

12. The lithium ion capacitor according to claim 8, wherein the graphite is used as an active material for adsorbing carrier ions of a charge/discharge reaction mechanism of an energy storage device and a conductive material for providing conductivity to the active material layer.

13. The lithium ion capacitor according to claim 8, wherein the active material comprises at least one of soft carbon, hard carbon, activated carbon, carbon aero gel, polyacrylonitrile (PAN), carbon nano fiber (CNF), activated carbon nano fiber (ACNE), and vapor grown carbon fiber (VGCF).

14. The lithium ion capacitor according to claim 8, wherein the current collector comprises a metal foil formed of at least one of copper, nickel, aluminum, and stainless steel.

15. The lithium ion capacitor according to claim 8, wherein the cathode structure comprises:
a cathode current collector; and
a cathode active material layer formed on the cathode current collector,
wherein the cathode active material layer includes a cathode active material that reversibly dope anions coupled to the lithium ions.

16. The lithium ion capacitor according to claim 8, wherein the electrolyte comprises at least one of LiPF₆, LiBF₄, LiSbF₆, LiAsF₅, LiClO₄, LiN, CF₃SO₃, LiC, LiN(SO₂CF₃)₂, LiN(SO₂C₂F₅)₂, LiC(SO₂CF₃)₂, LiPF₄(CF₃)₂, LiPF₃(C₂F₅)₃, LiPF₃(CF₃)₃, LiPF₅(iso-C₃F₇)₃, LiPF₅(iso-C₃F₇), (CF₂)₂(SO₂)₂NLi, and (CF₂)₃(SO₂)₂NLi.
